(19) United States
(12) Patent Application Publication
(10) Pub. No.: US 2016/0223378 A1
(43) Pub. Date: Aug. 4, 2016

(54) PRESSURE AND TEMPERATURE DETERMINING DEVICE, A PRESSURE AND TEMPERATURE SENSOR COMPRISING SUCH A DEVICE AND A METHOD FOR MANUFACTURING SUCH A DEVICE

(71) Applicant: MGI COUTIER, Champfromier (FR)

(72) Inventors: Ben Hammouda CHOKRI, Carpentras (FR); Marc NOVELLANI, Travaillan (FR)

(73) Assignee: MGI COUTIER, Champfromier (FR)

(21) Appl. No.: 15/013,105

(22) Filed: Feb. 2, 2016

(30) Foreign Application Priority Data
Feb. 2, 2015 (FR) 15/50795

(51) Int. Cl. G01F 9/00; G01F 1/69; G01F 1/34

(52) U.S. Cl. CPC G01F 9/001; G01F 1/34; G01F 1/69

(57) ABSTRACT

This pressure and temperature determining device comprises a membrane (2) having a face (4) in contact with the fluid (F), a pressure determining element (6), a temperature determining element (10) and a support for supporting the temperature determining element (10). The support has an implantation face which is opposite to the contact face (4). The temperature determining element (10) is disposed on the implantation face (12).

The present invention concerns a pressure and temperature determining device intended to determine pressures and temperatures of a fluid flowing, for example, in a motor vehicle. In addition, the present invention concerns a pressure and temperature sensor comprising such a pressure and temperature determining device. Moreover, the present invention concerns a method for manufacturing such a pressure and temperature determining device.

In particular, the present invention applies to the field of motor vehicles, in particular to utility vehicles, passenger vehicles and heavy goods vehicles, in order to determine and measure the pressures and the temperatures of different fluids flowing in such a vehicle, such as a fuel, oil, an aqueous urea solution (SCR) or air flowing in is the air intake circuit.

EP0893676A2 illustrates a pressure and temperature sensor comprising a pressure and temperature determining device, which comprises a membrane in contact with the fluid, a temperature determining element and a capacitive-type pressure determining element. As the temperature determining element is immersed in the fluid, the temperature determining element has a very short response time.

However, such a mounting reduces the service life of the pressure and temperature determining device, because the temperature determining element is exposed to corrosive fluids, such as a fuel. It is possible to encapsulate the temperature determining element in order to protect it from the fluid, but this significantly increases the manufacturing cost and the response time.

Furthermore, such a mounting requires piercing several passages in the membrane, in order to pass the electric connection legs of the temperature determining element, which may weaken the membrane and pollute the pressure and temperature determining device.

The present invention aims, in particular, to solve all or part of the aforementioned problems.

To this aim, an object of the invention is pressure and temperature determining device, intended to determine pressures and temperatures of a fluid flowing, for example, in a motor vehicle, the pressure and temperature determining device comprising at least:

a membrane having a contact face intended to be in contact with the fluid,

a pressure determining element secured to the membrane and comprising at least one piezoresistive track sensitive to the pressure,

a temperature determining element which is sensitive to the temperature, and

a support secured to the membrane and configured to support the temperature determining element;

The support has an implantation face opposite to the contact face, the temperature determining element being disposed on the implantation face.

Thus, such a mounting of the temperature determining element avoids the need of piercing passages in the membrane, thereby preserving the mechanical strength of the membrane and avoiding pollution of the pressure and temperature determining device.

In addition, such a mounting of the temperature determining element increases the service life of the pressure and temperature determining device, because the temperature determining element is isolated from the corrosive fluid, such as a fuel.

In the present application, the term [symbol] determine [symbol] and its derivatives means generating a signal representative of a physical quantity. Thus, a pressure determining element generates signals which are representative of the pressure, and a temperature determining element generates signals which are representative of the temperature.

A piezoresistive track may form a pressure determining element, because, under the effect of pressure exerted by the fluid on the contact face, the piezoresistive track undergoes an imbalance which is proportional to this pressure, thereby generating a voltage representative of this pressure. Indeed, a piezoresistive component has an electrical resistance which changes depending on a mechanical stress (pressure) undergone by this component.

Afterwards, an electronic unit can process the signals generated by the temperature determining element and by the pressure determining element. Depending on the application provided for the pressure and temperature determining device, the electronic unit may deliver an analog response or a digital response.

According to a variant, the temperature determining element may be disposed indirectly on the implantation face of the support. For example, it is possible to interpose, between the implantation face and the temperature determining element, a layer made, for example, of a thermally-conductive material.

According to an advantageous variant, the distance between the mounting face and the temperature determining element is smaller than 0.2 mm.

According to a variant, the face directed toward the membrane is generally parallel to the contact face.

According to a variant, the face directed toward the membrane totally or partially covers the contact face.

According to a variant, the membrane is composed of a ceramic, for instance comprising at least 95% of alumina, the membrane possibly having a thickness comprised between 0.1 mm and 0.5 mm, that is to say between 100 μm and 500 μm. Thus, such a ceramic allows the membrane to be rapidly deformed under the effect of the pressure exerted by the fluid, so that the or each piezoresistive track can determine the pressure of the fluid. In addition, such a ceramic allows for a rapid and accurate deposition of the piezoresistive and thermoresistive tracks.

According to a variant, the membrane is generally flat. Thus, such a membrane has a planar face, thereby simplifying the deposition of the or each piezoresistive track.

According to a variant, the membrane may have a generally elliptical, for example circular, shape, or a generally rectangular, for example square, shape.

According to a variant, the support further supports at least one electronic component, for example an integrated circuit.

According to an embodiment, the pressure and temperature determining device comprises a base forming the support, the base having a first base face directed toward the membrane and a second base face opposite to the membrane, the second base face forming the implantation face.

Thus, the distance between the fluid and the temperature determining element is limited to the thicknesses of the base and the membrane, thereby ensuring a relatively short response time.

According to a variant, the base and the membrane may be manufactured in an accurate manner according to the technique called [symbol] flush membrane [symbol] technique, in which the membrane may be affixed to the base via a sealing glass or glass seal.

According to a variant, the pressure and temperature determining device further comprises a glass seal secured on the base and on the membrane. Thus, such a glass seal allows making airtight a chamber surrounding the pressure determining element. In order to manufacture this glass seal, a glass paste (silica) has to be disposed between the membrane and the base, and then, heated up to the melting temperature of the glass.

According to a variant, the base comprises at least 95% of alumina, the base being configured to define a chamber around the pressure determining element. Thus, such a base defining the chamber allows carrying out relative or absolute pressure measurements.

According to a variant, the base has at least one vent hole opening, on the one hand, onto the membrane and, on the other hand, onto the outside of the pressure and temperature determining device. Thus, such a vent hole allows measuring relative pressures.

Alternatively, the base is configured so that the chamber is airtight. In other terms, the base is devoid of any vent hole. Thus, such a base allows measuring absolute pressures.

According to an embodiment, the pressure and temperature determining device comprises a printed circuit substrate forming the support, the printed circuit substrate having a first substrate face directed toward the membrane and a second substrate face opposite to the membrane, the second substrate face forming the implantation face.

Thus, the membrane may be manufactured according to the monolithic technique. Hence, the membrane is integral with the base, so that the membrane and the base form a monolithic set which is, for example, devoid of any glass seal. Then, the printed circuit substrate is assembled to the monolithic membrane.

In practice, the printed circuit substrate is sometimes called integrated circuit or electronic board or still referred to as [symbol] Printed Circuit Board [symbol] and abbreviated [symbol] PCB [symbol] .

According to a variant, the printed circuit substrate is flexible. Alternatively, the printed circuit substrate is rigid.

According to an embodiment, the membrane forms the support, and the membrane further has a dry face which is opposite to the contact face, the dry face forming the implantation face.

In this embodiment, the support is formed by the membrane itself. The contact face forms the other face of the support. Hence, the support-membrane has the contact face and the implantation face opposite to the contact face.

Thus, the response time of the temperature determining element is very short, whereas the accuracy of the temperature determining element is very high. Indeed, the membrane has a small thickness, typically comprised between 100 μm and 500 μm, thereby allowing for a rapid heat transfer through the membrane. This heat transfer is all the more rapid that there is no air or vacuum between the membrane and the temperature determining element.

Alternatively, the temperature determining element may be fastened indirectly on the implantation face of the membrane. For example, a layer may be interposed between the implantation face and the temperature determining element.

According to an embodiment, the temperature determining element is located, projected on a face of the membrane opposite to the contact face, substantially at the level of a peripheral outline delimiting the pressure determining element.

In other terms, the peripheral outline delimits a pressure measuring active area, which corresponds to an area of the membrane which is significantly deformed under the effect of pressure of the fluid on the contact face.

Thus, such an implantation of the temperature determining element allows maximizing the accuracy of the temperature measurement, while minimizing the response time of the temperature determining element.

In practice, when the pressure and temperature determining device is incorporated into a pressure and temperature sensor comprising a seal, for example an O-ring seal, the peripheral outline is included in a perimeter delimited by the inner edge of the seal. The inner edge of the seal defines the contour of a pressure measuring cavity in which the fluid comes into contact with the membrane.

According to a variant, the pressure determining element has dimensions comprised between 3 mm and 10 mm. In a variant where the pressure determining element has a generally circular perimeter, the diameter of the perimeter is comprised between 3 mm and 10 mm. Alternatively, the determining element may have a generally rectangular-shaped perimeter, the long side of which is comprised between 3 mm and 10 mm.

According to a variant, the pressure determining element extends over a surface area comprised between 7 mm² and 100 mm², for example equal to about 38 mm².

Advantageously, the distance between the temperature determining element and the peripheral outline, measured in the orthogonal projection on the implantation face, is smaller than 2 mm.

According to a variant, the temperature determining element is disposed outside the peripheral outline. Alternatively, for example depending on mounting constraints, the temperature determining element is disposed inside the peripheral outline.

According to an embodiment, a distance between the peripheral outline and a projection of a geometric center of the temperature determining element on the face of the membrane opposite to the contact face is comprised between −25% and +25% of the maximum dimension of the pressure determining element.

The aforementioned distance is measured along or parallel to a direction carrying this maximum dimension.

Thus, the temperature determining element is located substantially at the level of or facing the peripheral outline, thereby enhancing the accuracy of the measurements performed by the temperature determining element. Indeed, the area delimited by the peripheral outline is part of the portion of the membrane that heats up the most rapidly, because it is directly in contact with the fluid. Moreover, this area delimited by the peripheral outline allows for a rapid conduction of heat up to the temperature determining element, in particular by avoiding or bypassing the central region formed from air or vacuum, for example in the technology called [symbol] flush membrane [symbol] technology.

According to an embodiment, the temperature determining element consists of an electronic component, for example an electronic dipole.

In the present application, the term [symbol] electronic component [symbol] refers to an element intended to be assembled with other elements in order to form an electronic circuit.

Thus, such an electronic component is inexpensive, because it is widely available in the market. In addition, such an electronic component allows generating signals that can be easily exploited by a central unit of the motor vehicle. In other terms, the signals generated by such an electronic component are compatible with the central units of current motor vehicles.

Furthermore, such an electronic component simplifies the implementation of the pressure and temperature determining device, because the electronic component generally does not require any calibration nor tuning.

According to an embodiment, the temperature determining element comprises a thermistor, for instance selected from the group consisting of a Negative Temperature Coefficient thermistor, a Positive Temperature Coefficient thermistor and a platinum resistance thermometer.

Thus, such a thermistor generates measurement signals which can be operated by the central units that exist in current motor vehicles without any specific processing of these measurement signals

According to a variant, the platinum resistance thermometer may have a 100 ohms resistance (Pt100) or a 1000 ohms resistance (Pt1000).

According to a variant, the pressure and temperature determining device further comprises a thermally-insulating material disposed so as to totally or partially cover the temperature determining element. The thermally-insulating material may consist of a thermally-insulating resin, for example an epoxy, a mono- or a bi-component resin. Thus, such a thermally-insulating material allows minimizing the heat losses to the air located above the temperature determining element, thereby reducing the temperature measurement period, because the temperature of the temperature determining element is rapidly stabilized. Hence, the temperature determining element can provide more accurate measurements, because the thermally-insulating material reduces the influence of the ambient temperature.

According to a variant, the pressure and temperature determining device further comprises a thermally-conductive material disposed between the temperature determining element and the implantation face. Thus, such a thermally-conductive material allows maximizing the amount of heat transmitted by the membrane to the temperature determining element, thereby reducing the temperature measurement period and enhancing the accuracy of the temperature determining element.

According to an embodiment, the pressure and temperature determining device further comprises a securing product arranged so as to fasten the temperature determining element on the implantation face, the securing product being selected from the group consisting of a soldering paste, a solder metal and a weld metal.

Thus, such a securing product allows fastening the temperature determining element on the implantation face by bonding or by a surface mounting technique (sometimes referred to as [symbol] Surface Mount Technology [symbol] abbreviated [symbol] SMT [symbol] ).

According to a variant, said at least one piezoresistive track is printed over the membrane, for instance by screen-printing. Thus, the pressure and temperature determining device has a relatively low cost, because the piezoresistive tracks are obtained by printing, thereby allowing making very accurate printed tracks in a simple manner.

According to a variant, said at least one piezoresistive track is composed of at least one material selected from the group consisting of mineral matrices and organic polymeric matrices. Thus, such a material allows conferring good pressure-determining properties to the piezoresistive track, in particular in terms of gauge coefficient, linearity and hysteresis of the response curve, resolution, accuracy, response time. For example, the or each piezoresistive track may be composed of a ruthenate (ruthenium oxide).

According to a variant, said at least one piezoresistive track has thickness comprised between 1 μm and 100 μm.

According to a variant, said at least one piezoresistive track forms several pressure gauges spaced apart from each other, the pressure and temperature determining device further comprising conductive tracks linking the pressure gauges so as to form a pressure measuring electric circuit, for example a Wheatstone bridge. Thus, such pressure gauges, coupled to such a pressure measuring electric circuit, allow determining the pressure with a high accuracy and in a short response time. These conductive tracks may be composed of a Silver-Palladium (Pd—Ag) alloy.

In the present application, the terms [symbol] conduct [symbol] , [symbol] link [symbol] , [symbol] connect [symbol] and their derivatives refer to the electrical conduction.

Moreover, an object of the present invention is a pressure and temperature sensor, intended to measure pressures and temperatures of a fluid flowing, for example, in a motor vehicle, the pressure and temperature sensor comprising at least:

a pressure and temperature determining device according to the invention,

a connecting member configured to fluidly connect the contact face to a pipe for the fluid, and

an electronic unit configured to process signals and connected to the pressure determining element.

Thus, the pressure and temperature sensor has an extended service life and generates measurement signals which can be operated by the central units that exist in current motor vehicles without any specific processing of these measurement signals. In addition, such a combined pressure and temperature sensor is reliable, accurate and compact compared to a combined pressure and temperature sensor of the prior art.

In the present application, the term [symbol] sensor [symbol] refers to a set whose digital or analog response is representative of the measurement of physical quantities, in this instance, of the pressure and the temperature.

According to a variant, the electronic unit is further connected to the temperature determining element.

According to an embodiment, the pressure and temperature sensor further comprises a seal, for example an O-ring seal, which is compressed between the contact face and the connecting member, the connecting member having a passage for the fluid, said passage having a section similar to the shape of the seal after compression of the seal.

According to an embodiment, the seal defines a perimeter which surrounds the peripheral outline.

Thus, such a seal may define a perimeter which surrounds the peripheral outline, and hence the pressure determining element, and inside of which the temperature determining element may be disposed. According to a variant, the seal consists of an O-ring seal and the passage for the fluid, has a generally circular section the diameter of which is substantially equal to the inner diameter of the O-ring seal after compression of the O-ring seal.

According to a variant, the connecting member has a passage for the fluid with dimensions comprised between 2 mm and 8 mm. Thus, such dimensions allow minimizing the temperature response time while preserving a static pressure measurement.

According to a variant, the passage for the fluid is arranged perpendicular to the flow direction, of the fluid in the conduit on which the sensor is mounted. Thus it is possible to measure a static pressure.

Alternatively, the passage for the fluid may be arranged obliquely, for example at a 45-degree angle, to the flow direction of the fluid in the conduit on which the sensor is mounted.

According to a variant, the outer surface of the pressure and temperature sensor includes an electrically-conductive material coating. Thus, such a conductive coating may form an electromagnetic shield, for the purpose of complying with the electromagnetic compatibility (EMC) requirements.

Moreover, an object of the present invention is a manufacturing method, for manufacturing a pressure and temperature determining device according to the invention, the manufacturing method comprising the steps of:

depositing conductive tracks on the membrane, for instance through a first silk screen,

depositing said at least one piezoresistive track, for instance through a second silk-screen, so as to secure said at least one piezoresistive track on the membrane,

providing a support secured to the membrane, the support having an implantation face which is opposite to the contact face, and

disposing the temperature determining element on said implantation face.

The sequence of the steps of this manufacturing method may be modified without departing from the scope of the present invention.

According to a variant, subsequently to at least one of said deposition steps, the manufacturing method further comprises a step consisting of carrying out a steaming and a heat treatment suitable for evaporating the solvents.

According to a variant, the manufacturing method further comprises a step consisting of adjusting said at least one piezoresistive track by laser trimming. Thus, such a laser adjustment allows defining a pressure determining element with a high accuracy, thereby enhancing the performances of the pressure and temperature determining device.

Moreover, an object of the present invention is a motor vehicle comprising at least one such pressure and temperature sensor.

The aforementioned embodiments, and variants may be considered individually or according to any technically permissible combination.

The present invention will be well understood and its advantages will also appear in the light of the description that follows, given only as a non-limiting example and with reference to the appended figures, in which identical reference signs correspond to structurally and/or functionally similar elements. The appended figures are as follows:

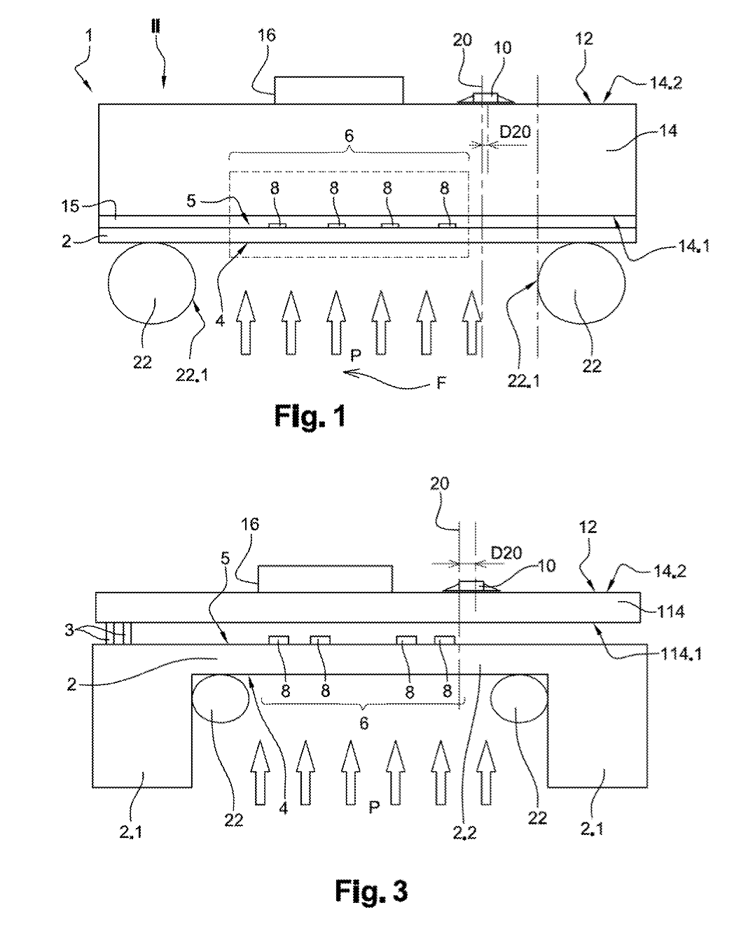

FIG. 1 is a schematic sectional view of a pressure and temperature determining device according to a first embodiment of the invention;

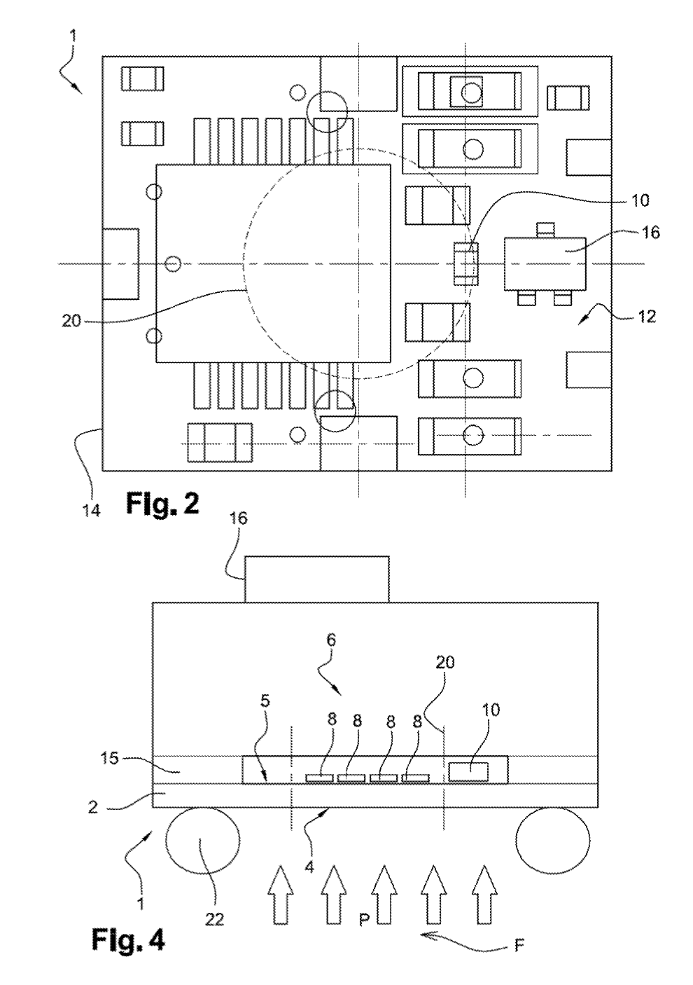

FIG. 2 is a schematic top view, along the arrow II in FIG. 1, of the pressure and temperature determining device of FIG. 1;

FIG. 3 is a schematic sectional view of a pressure and temperature determining device according to a second embodiment of the invention;

FIG. 4 is a schematic sectional view of a pressure and temperature determining device according to a third embodiment of the invention;

FIG. 5 is a schematic sectional view of a pressure and temperature sensor comprising the pressure and temperature determining device of FIG. 1; and

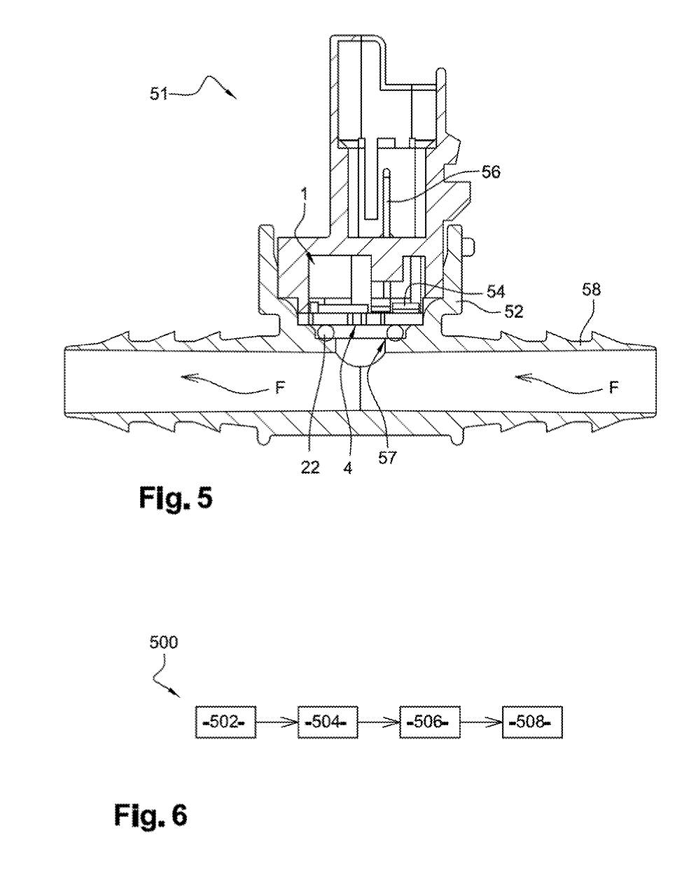

FIG. 6 is a flowchart illustrating a manufacturing method according to the invention.

FIGS. 1 and 2 illustrate a pressure and temperature determining device 1 according to a first embodiment of the invention. The pressure and temperature determining device 1 belongs to a pressure and temperature sensor which is intended to equip a motor vehicle which is not represented.

The pressure and temperature determining device 1 is intended to determine pressures, symbolized by the arrows P in FIG. 1, and to determine temperatures of a fluid which flows in the motor vehicle and the flow of which is symbolized, for example, by an arrow F.

The pressure and temperature determining device 1 comprises a membrane 2 which has, on the one hand, a contact face 4 intended to be in contact with the fluid F and, on the other hand, a dry face 5, which is opposite to the contact face 4. In the example of FIG. 1, the membrane 2 is composed of a ceramic comprising 96% of alumina. The membrane 2 here has a generally flat shape. The membrane 2 here has a thickness of about 0.25 mm.

The pressure and temperature determining device 1 further comprises a pressure determining element 6 which is sensitive to the pressure P and which is secured to the membrane 2. The pressure determining element 6 comprises piezoresistive tracks 8. The pressure determining element 6 is fastened on the membrane 2, hence in contact with the membrane 2.

In the present case, the piezoresistive tracks 8 are printed over the dry face 5 by screen-printing. The piezoresistive tracks 8 have each a thickness of about 10 μm. The membrane 2 has some flexibility, in order to transmit the pressure P to the piezoresistive tracks 8.

The piezoresistive tracks 8 form pressure gauges which are spaced apart from each other. The pressure and temperature determining device 1 further comprises conductive tracks which are not represented and which link these pressure gauges so as to form a pressure measuring electric circuit, which is here in the form of Wheatstone bridge. This Wheatstone bridge operates in a conventional manner which is commonly known.

The pressure and temperature determining device 1 further comprises a temperature determining element 10. The temperature determining element 10 here comprises a Negative Temperature Coefficient (NTC) thermistor.

In addition, the pressure and temperature determining device 1 comprises a support secured to the membrane 2 and configured to support the temperature determining element 10. The support has an implantation face which is opposite to the contact face 4 and on which the temperature determining element 10 is disposed. The distance between the implantation face 12 and the temperature determining element is here equal to about 0.05 mm. Alternatively, the temperature determining element may be in direct contact with the implantation face.

In the example of FIG. 1, the pressure and temperature determining device 1 comprises a base 14 which forms the support configured to support the temperature determining element 10. The support which forms the base 14 is secured to the membrane 2. The base 14 may further support electronic components, for example an integrated circuit 16 (sometimes known as ASIC of the term [symbol] Application-Specific Integrated Circuit [symbol] ). The base 14 may be composed of a ceramic comprising, for example, 96% of alumina.

The base 14 has, on the one hand, a first base face 14.1 which is directed toward the membrane 2 and, on the other hand, a second base face 14.2 which is opposite to the membrane 2. The second base face 14.2 forms the implantation face 12, on which the temperature determining element 10 is located. The first base face 14.1 is generally parallel to the contact face 4. The first base face 14.1 here partially covers the contact face 4.

In addition, the pressure and temperature determining device 1 comprises a glass seal 15 located between the membrane 2 and the base 14. In order to manufacture the glass seal, it is possible, for example, to dispose a glass paste between the membrane 2 and the base 14, and then heat up to the melting temperature of the glass.

In operation, when the fluid F comes into contact with the contact face 4, the membrane 2 is brought to the temperature of the fluid and then transfers the heat of the fluid F to the base 14, thereby bringing the temperature determining element 10 to a temperature representative of the fluid F. The temperature determining element 10 generates an analog or digital signal representative of the temperature of the fluid F. This analog or digital signal may be generated directly by the temperature determining element 10 or indirectly, for example via the integrated circuit 16,

The pressure and temperature determining device 1 further comprises a securing product arranged so as to fasten the temperature determining element 10 on the implantation face 12. In the present case, the securing product consists of a soldering paste. This securing product fastens the temperature determining element 10 on the implantation face 12 by a surface mounting technique (sometimes referred to as [symbol] Surface Mount Technology [symbol] abbreviated [symbol] SMT [symbol] ).

As shown in FIG. 2, the base 14 includes one or several electronic component(s) on the second base face 14.2, for example, the ASIC integrated circuit 16. The base 14 is secured to the membrane 2. In addition, the base 14 is electrically connected to the membrane 2.

Besides, the temperature determining element 10 is located, in projection on the dry face 5, substantially facing or at the level of a peripheral outline 20 which delimits the pressure determining element 6. In the example of FIGS. 1 and 2, the pressure determining element 6 occupies a substantially circular-shaped space, so that the peripheral outline 20 substantially forms a circle. This circle here has a diameter equal to about 5 mm.

A distance 020 between the peripheral outline 20 and a projection of a geometric center of the temperature determining element 10 on the face of the membrane opposite to the contact face 4, is smaller than 25% of the maximum dimension of the pressure determining element 6.

When the pressure and temperature determining device 1 is assembled in a pressure and temperature sensor 51, visible in FIG. 5 and comprising a seal 22 compressed against the contact face 4, the seal 22 delimits the portion of the membrane in contact with the fluid F. The inner edge 22.1 of the seal 22 defines a perimeter which surrounds the peripheral outline 20. In the example of FIG. 1, the projection of the geometric center of the temperature determining element 10 on the face of the membrane opposite to the contact face 4 is located between the peripheral outline 20 and the perimeter defined by the inner edge 22.1 of the seal 22 in the compressed state, thus, after assembling the pressure and temperature determining device 1.

FIG. 3 illustrates a pressure and temperature determining device 1 according to a second embodiment of the invention. To the extent that the pressure and temperature determining device 1 of FIG. 3 is similar to the pressure and temperature determining device 1 of FIGS. 1 and 2, the description of the sensor 1, given hereinbefore in connection with FIGS. 1 and 2, may be transposed to the pressure and temperature determining device 1 of FIG. 3, with the exception of the notable differences set out hereinafter.

The pressure and temperature determining device 1 of FIG. 3 differs from the pressure and temperature determining device 1 of FIGS. 1 and 2, because the pressure and temperature determining device 1 of FIG. 3 comprises a printed circuit substrate 114 forming the support, and because the pressure and temperature determining device 1 of FIG. 3 comprises no base.

The printed circuit substrate 114 has, on the one hand, a first substrate face 114.1 which is directed toward the membrane 2 and, on the other hand, a second substrate face 114.2 which is opposite to the membrane 2. The second substrate face 114.2 forms the implantation face 12 on which the temperature determining element 10 is disposed.

In addition, the pressure and temperature determining device 1 of FIG. 3 differs from the pressure and temperature determining device 1 of FIGS. 1 and 2, because the projection of the geometric center of the temperature determining element 10 on the face of the membrane opposite to the contact face 4 is located at the level of the seal 22.

Besides, the pressure and temperature determining device 1 of FIG. 3 differs from the pressure and temperature determining device 1 of FIGS. 1 and 2, because the membrane 2 has a peripheral wall 2.1 which extends around a flat-shaped central portion 2.2, whereas the membrane 2 of FIGS. 1 and 2 is generally flat and devoid of any peripheral wall. In particular, the peripheral wall 2.1 serves to position and to wedge the seal 22.

As in the first embodiment illustrated in FIGS. 1 and 2, the pressure determining element 6 occupies a substantially circular space, as shown in FIG. 3, so that the peripheral outline 20 substantially forms a circle. Like in FIGS. 1 and 2, the pressure determining element 6 is fastened on the membrane 2, hence in contact with the membrane 2.

As in the first embodiment illustrated in FIGS. 1 and 2, a distance D20 between the peripheral outline 20 and a projection of a geometric center of the temperature determining element 10 on the face of the membrane opposite to the contact face, is smaller than 25% of the maximum dimension of the pressure determining element 6. The projection of the geometric center of the temperature determining element 10 here is located outside of the peripheral outline 20.

FIG. 4 illustrates a pressure and temperature determining device 1 according to a third embodiment of the invention. To the extent that the pressure and temperature determining device 1 of FIG. 4 is similar to the pressure and temperature determining device 1 of FIGS. 1 and 2, the description of the sensor 1, given hereinbefore in connection with FIGS. 1 and 2, may be transposed to the pressure and temperature determining device 1 of FIG. 4, with the exception of the notable differences set out hereinafter.

The pressure and temperature determining device 1 of FIG. 4 differs from the pressure and temperature determining device 1 of FIGS. 1 and 2, essentially because the membrane 2 forms the support, whereas in the embodiment of FIGS. 1 and 2, the support is formed by the base 14.

Furthermore, the membrane 2 has a dry face 5 which is opposite to the contact face 4 and which forms the implantation face, on which the temperature determining element 10 is disposed or located. As in the example of FIG. 1, the piezoresistive tracks 8 are printed over the dry face 5 by screen-printing in order to form the pressure determining element 6.

FIG. 5 illustrates a pressure and temperature sensor 51 intended to measure pressures P and temperatures of a fluid F flowing, for example, in a motor vehicle.

The pressure and temperature sensor 51 comprises the pressure and temperature determining device 1 of FIG. 4, as well as a connecting member 52 configured to fluidly connect the contact face 4 to a pipe 58 of the fluid F. The function of the pipe 58 is to transfer the fluid F between two components of the motor vehicle.

In addition, the pressure and temperature sensor 51 comprises an electronic unit 54 configured to condition signals which are generated by the pressure determining element 6 and, if required, by the temperature determining element 10. The electronic unit 54 is connected, on the one hand, to the pressure determining element 6 and, on the other hand, to the temperature determining element 10.

In the example of FIG. 5, the electronic unit 54 is formed on a printed circuit which is affixed to the base 4 in hybrid technology. The electronic unit 54 may comprise a signal amplifier which is not represented. The electronic unit 54 may deliver an analog or digital response at the outlet terminals of a connector 56.

The pressure and temperature sensor 51 further comprises the seal 22, in this instance an O-ring seal, which is compressed between the contact face 4 and the connecting member 52, the connecting member having a passage 57 for the fluid F having a section similar to the shape of the seal 22 after compression of the seal 22. The inner edge 22.1 of the seal 22 defines the contour of a pressure measuring cavity in which the fluid F comes into contact with the membrane 2.

The passage 57 of the connecting member 52 here has a generally circular section, the diameter of which is substantially equal to the inner diameter of the seal 22 after its compression, thereby avoiding or limiting the emergence of fluid F stagnation areas. The diameter of the passage 57 is here equal to about 5.5 mm. In operation, the fluid F flows from the pipe 58 up to the contact face 4 through the passage 57.

Besides, as shown in FIG. 5, the pipe 58 is of the [symbol] fir fitting [symbol] type, because it has annular ribs intended for the attaching of a flexible hose which is not represented and through which the fluid flows.

The connecting member 52 is configured so as to be connected transversally, here, perpendicularly, to the flow direction of the fluid F in the pipe 58 belonging to the motor vehicle. Thus, the pressure and temperature sensor disturbs the flow of the fluid F as little as possible.

The connecting member 52 and the connector 56 are here composed of polyamide (PA). The connecting member 52 is here filled with a conductive material such as carbon nanotube filler, carbon black or another electrically-conductive filler, thereby avoiding the accumulation of electrostatic fillers. The outer surface of the pressure and temperature sensor 51 may include an electrically-conductive material coating, thereby forming an electromagnetic shield.

FIG. 6 illustrates a manufacturing method 500, for manufacturing the pressure and temperature determining device 1. This manufacturing method 500 comprising the steps of

502) depositing conductive tracks over the membrane, for instance through a first silk-screen,

504) depositing said at least one piezoresistive track 8, for instance through a second silk-screen, so as to secure said at least one piezoresistive track 8 on the membrane 2,

505) providing a support secured to the membrane 2, the support having an implantation face 12 which is opposite to the contact face 4, and

506) disposing the temperature determining element 10 on said implantation face 12.

The manufacturing method 500 further comprises assembly steps consisting of securing the membrane 2 and the glass seal 15 on the base 14.

The manufacturing method 500 further comprises a step 508) consisting of adjusting the piezoresistive tracks 8 by laser trimming. Subsequently to each of the deposition steps 502), 504) and 506), the manufacturing method 500 further comprises steps which consist, respectively, of carrying out a steaming and a heat treatment suitable for evaporating the solvents implemented during the deposition steps 502), 504) and 506).

After having manufactured the pressure and temperature determining device, it is possible to assemble it in the pressure and temperature sensor 51, for example by means of laser welds.

In operation, as shown in FIG. 5, the fluid F flows in the pipe 58. In operation, the fluid F flows from the pipe 58 up to the contact face 4 through the passage 57.

After the fluid F has come into contact with the contact face 4, the membrane 2 transmits the pressure of the fluid F to the piezoresistive tracks and the temperature determining element 10 is brought to the temperature of the membrane 2, which is representative of the temperature of the fluid F. Thus, the pressure and temperature determining device 1 determines the pressure P and the temperature of the fluid F.

Then, the electronic unit 54 collects and processes the signals emitted by the pressure and temperature determining device 1. This processing may consist in amplifying these signals by means of an Application-Specific Integrated Circuit (ASIC).

After this processing, the electronic unit 54 generates the response of the pressure and temperature sensor 51. This analog or digital response can be read by, a central unit of the motor vehicle, in order to assess the pressure P and the temperature of the fluid F.

Of course, the invention is not limited to the particular examples described in the present application. Other embodiments within the reach of those skilled in the art may also be considered without departing from the scope of the invention defined by the claims hereinafter.

1. A pressure and temperature determining device, intended to determine pressures and temperatures of a fluid flowing, for example, in a motor vehicle, the pressure and temperature determining device comprising at least:
a membrane having a contact face intended to be in contact with the fluid,
a pressure determining element secured to the membrane and comprising at least one piezoresistive track sensitive to the pressure,
a temperature determining element which is sensitive to the temperature, and
a support secured to the membrane and configured to support the temperature determining element;
wherein the support has an implantation face which is opposite to the contact face, the temperature determining element being disposed on the implantation face.

2. The pressure and temperature determining device according to claim 1, further comprising a base forming the support, the base having a first base face directed toward the membrane and a second base face opposite to the membrane, the second base face forming the implantation face.

3. The pressure and temperature determining device according to claim 1, further comprising a printed circuit substrate forming the support, the printed circuit substrate having a first substrate face directed toward the membrane and a second substrate face opposite to the membrane, the second substrate face forming the implantation face.

4. The pressure and temperature determining device according to claim 1, wherein the membrane forms the support, and wherein the membrane further has a dry face which is opposite to the contact face, the dry face forming the implantation face.

5. The pressure and temperature determining device according to claim 1, wherein the temperature determining element is located, projected on a face of the membrane opposite to the contact face, substantially at the level of a peripheral outline delimiting the pressure determining element.

6. The pressure and temperature determining device according to claim 5, wherein a distance between the peripheral outline and a projection of a geometric center of the temperature determining element on the face of the membrane opposite to the contact face is comprised between −25% and +25% of the maximum dimension of the pressure determining element.

7. The pressure and temperature determining device according to claim 1, wherein the temperature determining element consists of an electronic component, for example an electronic dipole.

8. The pressure and temperature determining device according to claim 7, wherein the temperature determining element comprises a thermistor.

9. The pressure and temperature determining device according to claim 8, wherein the thermistor is selected from the group consisting of a Negative Temperature Coefficient thermistor, a Positive Temperature Coefficient thermistor and a platinum resistance thermometer.

10. The pressure and temperature determining device according to claim 1, further comprising a securing product arranged so as to fasten the temperature determining element on the implantation face, the securing product being selected from the group consisting of a soldering paste, a solder metal and a weld metal.

11. A pressure and temperature sensor, intended to measure pressures and temperatures of a fluid flowing, for example, in a motor vehicle, the pressure and temperature sensor comprising at least:
a pressure and temperature determining device according to claim 1,
a connecting member configured to fluidly connect the contact face to a pipe for the fluid, and
an electronic unit configured to process signals and connected to the pressure determining element.

12. The pressure and temperature sensor, according to claim 11, further comprising a seal, for example an O-ring seal, which is compressed between the contact face and the connecting member, the connecting member having a passage for the fluid, said passage having a section similar to the shape of the seal after compression of the seal.

13. The pressure and temperature sensor according to claim 12, wherein the seal defines a perimeter which surrounds the peripheral outline.

14. A manufacturing method, for manufacturing a pressure and temperature determining device according to claim 1, the manufacturing method comprising the steps of:
depositing conductive tracks over the membrane,
depositing said at least one piezoresistive track, so as to secure aid at least one piezoresistive track on the membrane,
providing a support secured to the membrane, the support having an implantation face which is opposite to the contact face, and
disposing the temperature determining element on said implantation face.

15. The manufacturing method according to claim 14, wherein the conductive tracks depositing step includes depositing through a first silk-screen, and the piezoresistive track depositing step includes depositing through a second silk-screen.
